(19) United States
(12) Patent Application Publication
(10) Pub. No.: US 2024/0239481 A1
(43) Pub. Date: Jul. 18, 2024

(54) A SYSTEM AND A METHOD OF VIBRATION MITIGATION FOR AN PROPULSOR AND A BOOM IN AN ELECTRIC AIRCRAFT

(71) Applicant: BETA AIR, LLC, SOUTH BURLINGTON, VT (US)

(72) Inventors: Herman Wiegman, SOUTH BURLINGTON, VT (US); Kyle Clark, SOUTH BURLINGTON, VT (US)

(73) Assignee: BETA AIR, LLC, SOUTH BURLINGTON, VT (US)

(21) Appl. No.: 18/097,747

(22) Filed: Jan. 17, 2023

(51) Int. Cl. B64C 27/00

(52) U.S. Cl. CPC B64C 27/001; B64C 29/0008

(57) ABSTRACT

A system of vibration mitigation for a propulsor and a boom in an electric aircraft is disclosed. The system may include at least a propulsor, wherein the at least a propulsor is configured to propel an electric aircraft through a fluid medium and the at least a propulsor comprises a driving frequency from 0 to its maximum driving frequency that is generated as a function of a rotational speed of the at least a propulsor when the at least a propulsor propels the electric aircraft through the fluid medium. The system may include at least a boom, wherein the at least a boom comprises the at least a propulsor mounted on the at least a boom and a natural frequency of the at least a boom, wherein the natural frequency is a fraction of the maximum driving frequency of the at least a propulsor.

### FIELD OF THE INVENTION

The present invention generally relates to the field of electric aircraft. In particular, the present invention is directed to of vibration mitigation for a propulsor and a boom in an electric aircraft.

### BACKGROUND

Electric aircraft presents a great promise for the future. Specifically, electric aircraft will allow human flight to be performed without need to burn fossil fuels. The electric aircraft must be made of a stable structure. Existing solutions to make the structure of the electric aircraft stable is not sufficient.

### SUMMARY OF THE DISCLOSURE

In an aspect, a system of vibration mitigation for a propulsor and a boom in an electric aircraft is disclosed. The system may include at least a propulsor, wherein the at least a propulsor is configured to propel an electric aircraft through a fluid medium and the at least a propulsor comprises a driving frequency from 0 to its maximum driving frequency that is generated as a function of a rotational speed of the at least a propulsor when the at least a propulsor propels the electric aircraft through the fluid medium. The system may include at least a boom, wherein the at least a boom comprises the at least a propulsor mounted on the at least a boom and a natural frequency of the at least a boom, wherein the natural frequency is a fraction of the maximum driving frequency of the at least a propulsor.

In another aspect, method of vibration mitigation for a propulsor and a boom in an electric aircraft is disclosed. The method may include obtaining at least a propulsor, wherein the propulsor is configured to rotate at rotational speed. The method may include determining a maximum rotational speed of the at least a propulsor. The method may include determining a natural frequency of at least a boom as a function of the maximum driving frequency of the at least a propulsor. The method may include mounting the at least a propulsor to the at least a boom. The method may include rotating the at least a propulsor at the rotational speed. The method may include generating a driving frequency of the at least a propulsor with a range from 0 to the maximum driving frequency as a function of the rotational speed.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an exemplary embodiment of an electric aircraft with a propulsor and a boom;

FIG. 2 illustrates an exemplary embodiment of an integrated electric propulsion assembly;

FIG. 3 is an exemplary embodiment of a portion of structure of an electric aircraft;

FIG. 4 is an exemplary diagram of the cross-sectional view of a motor assembly in a boom; and

FIG. 5 is a flow diagram of a method of vibration mitigation for a propulsor and a boom in an electric aircraft.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, a system of vibration mitigation for a propulsor and a boom in an electric aircraft is disclosed. The system may include at least a propulsor, wherein the at least a propulsor is configured to propel an electric aircraft through a fluid medium and the at least a propulsor comprises a driving frequency from 0 to its maximum driving frequency that is generated as a function of a rotational speed of the at least a propulsor when the at least a propulsor propels the electric aircraft through the fluid medium. The system may include at least a boom, wherein the at least a boom comprises the at least a propulsor mounted on the at least a boom and a natural frequency of the at least a boom, wherein the natural frequency is a fraction of the maximum driving frequency of the at least a propulsor. Exemplary embodiments illustrating aspects of the present disclosure are described below in the context of several specific examples.

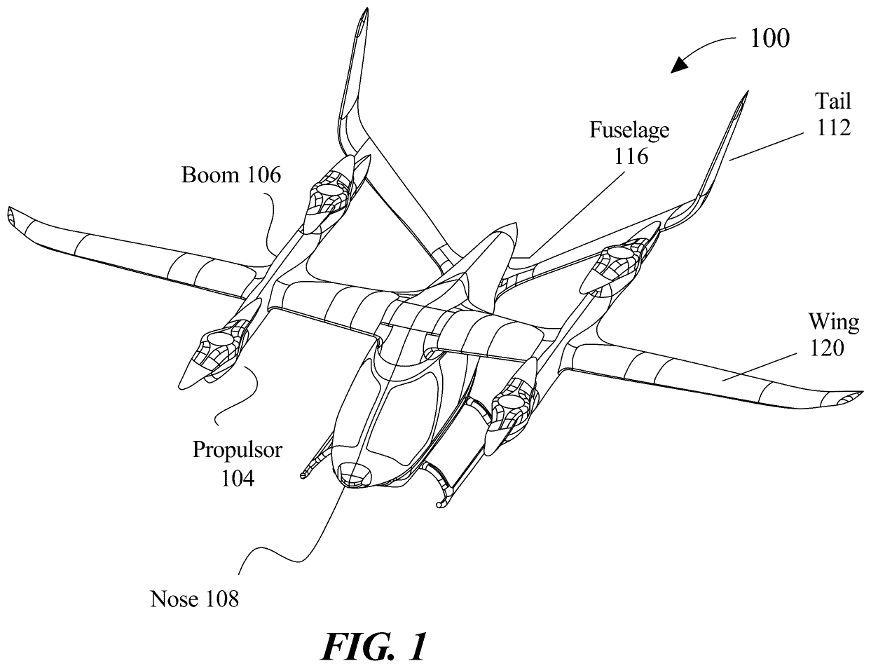

For purposes of description in this disclosure, the terms “up”, “down”, “forward”, “horizontal”, “left”, “right”, “above”, “below”, “beneath”, “top”, “bottom” and derivatives thereof shall relate to the invention as oriented in FIG. 1. Furthermore, there is no intention to be bound by any expressed or implied theory presented in the preceding technical field, background, brief summary, or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed in this disclosure are not to be considered as limiting, unless the claims expressly state otherwise.

Referring now to FIG. 1, an exemplary embodiment of an electric aircraft 100 with at least a propulsor 104 and at least a boom 106 is illustrated in accordance with one or more embodiments of the present disclosure. As used in this disclosure an “aircraft” is vehicle is able to fly. As a non-limiting example, an aircraft may include airplanes, helicopters, airships, blimps, gliders, paramotors, and the like thereof. As used in this disclosure, an “electric aircraft” is an aircraft that is at least primarily electrically powered. Electric aircraft may be capable of rotor-based cruising flight, rotor-based takeoff, rotor-based landing, fixed-wing cruising flight, airplane-style takeoff, airplane-style landing, and/or any combination thereof. “Rotor-based flight,” as described in this disclosure, is where the aircraft generates lift and propulsion by way of one or more powered rotors coupled with an engine, such as a quadcopter, multi-rotor helicopter, or other vehicle that maintains its lift primarily using downward thrusting propulsors. “Fixed-wing flight,” as described in this disclosure, is a mode of flight where the aircraft is primarily generates lift using wings and/or foils that generate lift caused by the aircraft's forward airspeed and the shape of the wings and/or foils, such as airplane-style flight.

With continued reference to FIG. 1, in some embodiments, an electric aircraft may be an electric vertical takeoff and landing (eVTOL) aircraft. An “eVTOL,” for the purposes of this disclosure, is an electric aircraft that can hover, take off, and land vertically. An eVTOL, as used herein, is an electrically powered aircraft typically using an energy source of a plurality of energy sources to power the aircraft. In order to optimize the power and energy necessary to propel the aircraft, eVTOL may be capable of rotor-based cruising flight, rotor-based takeoff, rotor-based landing, fixed-wing cruising flight, airplane-style takeoff, airplane-style landing, and/or any combination thereof. A “energy source” may include a plurality of energy sources, referred to herein as a module of energy sources. The module may include batteries connected in parallel or in series or a plurality of modules connected either in series or in parallel designed to satisfy both power and energy requirements. Exemplary energy sources are disclosed in detail in U.S. patent application Ser. Nos. 16/948,157 and 16/048,140 both entitled “SYSTEM AND METHOD FOR HIGH ENERGY DENSITY BATTERY MODULE” by S. Donovan et al., which are incorporated in their entirety herein by reference. The eVTOL aircraft may include a flight transition. The “flight transition,” as used in this disclosure, is a transition where an eVTOL aircraft changes its flight mode from vertical flight to forward flight or from forward flight to vertical flight. A “vertical flight mode,” as used in this disclosure, refers to a mode of an aircraft to propel an aircraft in a vertical direction, such as but not limited to vertical takeoff, vertical landing, and the like. In some embodiments, a lift propulsor may be used to perform vertical flight. The lift propulsor is further disclosed below. A “forward flight mode,” as used in this disclosure, refers to a mode of an aircraft to propel an aircraft in a horizontal direction. As a non-limiting example, the forward flight mode may include a “airplane” mode. In some embodiments, a forward propulsor may be used to perform forward flight. The forward propulsor is further disclosed below.

With continued reference to FIG. 1, and in one or more embodiments, aircraft 100 may include motor, which may be mounted on a structural feature of an aircraft. Design of motor may enable it to be installed external to the structural member (such as a boom, nacelle, or fuselage) for easy maintenance access and to minimize accessibility requirements for the structure. This may improve structural efficiency by requiring fewer large holes in the mounting area. This design may include two main holes in the top and bottom of the mounting area to access bearing cartridge. Further, a structural feature may include a component of aircraft 100. For example, and without limitation structural feature may be any portion of a vehicle incorporating motor, including any vehicle as described below. As a further non-limiting example, a structural feature may include without limitation a wing, a spar, an outrigger, a fuselage, or any portion thereof; persons skilled in the art, upon reviewing the entirety of this disclosure, will be aware of many possible features that may function as at least a structural feature. At least a structural feature may be constructed of any suitable material or combination of materials, including without limitation metal such as aluminum, titanium, steel, or the like, polymer materials or composites, fiberglass, carbon fiber, wood, or any other suitable material. As a non-limiting example, at least a structural feature may be constructed from additively manufactured polymer material with a carbon fiber exterior; aluminum parts or other elements may be enclosed for structural strength, or for purposes of supporting, for instance, vibration, torque or shear stresses imposed by at least propulsor 104. Persons skilled in the art, upon reviewing the entirety of this disclosure, will be aware of various materials, combinations of materials, and/or constructions techniques.

With continued reference to FIG. 1, aircraft 100 may include a propulsor 104. As used in this disclosure, a “propulsor” is a component or a device that is used to propel a craft by exerting force on a fluid medium using electrical power. As a non-limiting example, the craft may include an electric aircraft, an eVTOL aircraft, and the like. As used in this disclosure, a “fluid medium” is a substance that continuously flows under an applied shear stress or external force. As a non-limiting example, the fluid medium may include air, water, and the like. In some embodiments, the at least a propulsor 104 may be connected to an electrical power source. As a non-limiting example, the electrical power source may include a battery pack. In some embodiments, the at least a propulsor 104 may include a rotor, a propeller, a blade, a blade arrangement, or the like. As used in this disclosure, a “propeller” is a device that rotates and exerts force to generate a lift for an aircraft. In some embodiments, propeller may include a blade. In some embodiments, propeller may include a plurality of blades. As used in this disclosure a “blade” is a component of a propeller that converts rotary motion from an engine or other power source into a swirling slipstream. In some embodiments, the blade may include a solid blade. As used herein, a “solid blade” is a blade that is substantially rigid and not susceptible to bending during flight.

With continued reference to FIG. 1, in some embodiments, at least a propulsor 104 may include a lift propulsor. As used in this disclosure, a “lift propulsor” is a propulsor that provides vertical lift to an aircraft. A “lift,” for the purposes of this disclosure, is an aerodynamic force, generated by a solid body moving through a fluid perpendicular to the relative freestream velocity. In some embodiments, the vertical lift may be provided during transition of the aircraft between vertical and horizontal modes of flight, along with a forward thrust. In some embodiments, the at least a propulsor 104 may include a forward propulsor. As used in this disclosure, a “forward propulsor” is a propulsor that produces forward thrust to an aircraft. As used in this disclosure a “forward thrust” is a thrust that forces aircraft through a medium in a horizontal direction, wherein a horizontal direction is a direction parallel to the longitudinal axis. For example, forward thrust may include a force of 1145 N to force aircraft to in a horizontal direction along the longitudinal axis. As

With continued reference to FIG. 1, and in one or more embodiments, at least a propulsor 104 includes a motor. The motor may include, without limitation, any electric motor, where an electric motor is a device that converts electrical energy into mechanical energy, for instance by causing a shaft to rotate. A motor may be driven by direct current (DC) electric power; for instance, a motor may include a brushed DC motor or the like. A motor may be driven by electric power having varying or reversing voltage levels, such as alternating current (AC) power as produced by an alternating current generator and/or inverter, or otherwise varying power, such as produced by a switching power source. A motor may include, without limitation, a brushless DC electric motor, a permanent magnet synchronous motor, a switched reluctance motor, and/or an induction motor; persons skilled in the art, upon reviewing the entirety of this disclosure, will be aware of various alternative or additional forms and/or configurations that a motor may take or exemplify as consistent with this disclosure. In addition to inverter and/or switching power source, a circuit driving motor may include electronic speed controllers (not shown) or other components for regulating motor speed, rotation direction, torque, and the like.

With continued reference to FIG. 1, at least a propulsor 104 includes a driving frequency that is generated as a function of a rotational speed of the at least a propulsor 104 when the at least a propulsor 104 propels the electric aircraft through a fluid medium. As a non-limiting example, the fluid medium may include air. As used in this disclosure, a “rotational speed” of a propulsor is the number of turns of the propulsor in the certain period of time. The unit of the rotational speed may be revolutions per minute (rpm). As a non-limiting example, the rotational speed of the at least a propulsor 104 may include a range of 0 rpm to its maximum rotational speed of the at least a propulsor 104. As used in this disclosure, a “maximum rotational speed” of a propulsor is the maximum number of rotations of the propulsor in the certain period of time. As a non-limiting example, the maximum rotational speed of the at least a propulsor 104 may include 3600 rpm. As another non-limiting example, the maximum rotational speed of the at least a propulsor 104 may be lower than 3600 rpm. As another non-limiting example, the maximum rotational speed of the at least a propulsor 104 may be higher than 3600 rpm. In some embodiments, the rotational speed of the at least a propulsor 104 may be used to control attitude of an electric aircraft. For example, in the case of an eVTOL with four lift propulsors, the rotational speed of blades of each lift propulsor may be adjusted to create differing lift vectors. The difference in lift vectors may cause a moment on the eVTOL which may cause an attitude change in the eVTOL. In some embodiments, the rotational speed of the at least a propulsor 104 may get increased to generate more lift for an electric aircraft. In some embodiments, the driving frequency of the at least a propulsor 104 may be calculated as a function of the rotational speed of the at least a propulsor 104. As used in this disclosure, a “driving frequency” is the frequency of a driving force. As used in this disclosure, a “driving force” is an influence that can change the motion of an object. As a non-limiting example, the driving force may be applied to at least a boom 106 as a vibration of the at least a propulsor 104 in the driving frequency. The unit of the driving frequency may be hertz (Hz). As a non-limiting example, the driving frequency may include 60 Hz. In some embodiments, the rotational speed of the at least a propulsor may be converted to the driving frequency of the at least a propulsor 104 using a following equation: 1 Hz=60 rpm. As a non-limiting example, 0 rpm may be converted to 0 Hz. As another non-limiting example, 10 Hz may be converted to 600 rpm. As another non-limiting example, 3600 rpm may be converted to 60 Hz. In an embodiment, when the rotational speed of the at least a propulsor 104 increases, the driving frequency of the at least a propulsor 104 may increase. In another embodiment, when the rotational speed of the at least a propulsor 104 decreases, the driving frequency of the at least a propulsor 104 may decrease In some embodiments, the driving frequency may include a range of 0 Hz to its maximum driving frequency. As a non-limiting example, a “maximum driving frequency” of a propulsor is the maximum frequency of the driving force of the propulsor. In some embodiments, the maximum driving frequency of the at least a propulsor 104 may be calculated using the maximum rotational speed of the at least a propulsor 104. As a non-limiting example, using the equation of 1 Hz=60 rpm, when the maximum rotational speed of the at least a propulsor 104 is 3600 rpm, the maximum driving frequency of the at least a propulsor 104 may be 60 Hz.

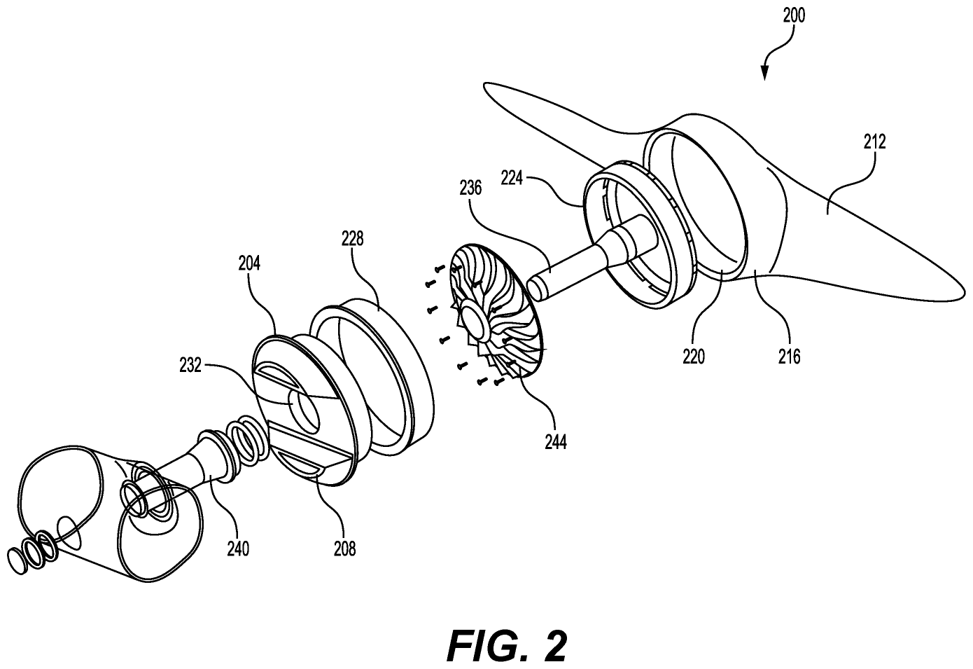

With continued reference to FIG. 1, in some embodiments aircraft 100 may include at least a boom 106. As used in this disclosure, a “boom” is a structural component of an aircraft that carries one or more components of an aircraft. As a non-limiting example, a component may include a propulsor, a battery pack, and the like. The propulsor disclosed herein may be consistent with an integrated electric propulsion assembly described with respect to FIG. 2. In some embodiments, aircraft 100 may include a plurality of the at least a boom 106. As a non-limiting example, aircraft 100 may include two the at least a boom 106, three the at least a boom 106, and the like. In an embodiment, the at least a boom 106 may include a cylindrical body. As used in this disclosure, a “cylindrical body” refers to an object that has the shape of a cylinder. In another embodiment, the at least a boom 106 may include a cuboid body. In some embodiments, the at least a boom 106 may be hollow. In some embodiments, the at least a boom 106 may be attached to at least a portion of a wing 120. The wing 120 of the aircraft disclosed herein is described further in detail below. In some embodiments, the at least a boom 106 may be attached to at least a portion of a tail of the aircraft. As used in this disclosure, a “tail” of an aircraft is a structure at the rear of an aircraft that provides stability during flight. The tail disclosed herein is described further detail below. In some embodiments, at least a portion of at least a boom 106 may be attached to at least a portion of a fuselage of aircraft 100. Additionally without limitation, additional disclosure related to the at least a boom 106 can be found in U.S. patent application Ser. No. 18/096,995, filed on Jan. 13, 2023 and entitled “A STRUCTURE OF AN ELECTRIC AIRCRAFT,” the entirety of which is incorporated herein by reference.

With continued reference to FIG. 1, at least a boom 106 includes at least a propulsor 104 mounted on the at least a boom 106. In an embodiment, at least a propulsor 104 may be mounted on a tip of at least a boom 106. In another embodiment, at least a propulsor 104 may be mounted in the middle of at least a boom 106, In some embodiments, at least a propulsor 104 can be mounted at any point on at least a boom 106. In some embodiments, a plurality of at least a propulsor 104 may be mount on at least a boom 106. As a non-limiting example, first at least a propulsor 104 may be mounted on a first tip of at least a boom 106 while second at least a propulsor 104 is mounted on a second tip of the at least a boom 106. Exemplary configuration is shown in FIG. 1 In some embodiments, the at least a boom 106 may include a recess. As used in this disclosure, a “recess” is a receding or hollow place in a surface of an object. In an embodiment, the at least a boom 106 may include a recess on an upper surface of the at least a boom 106. In another embodiment, the at least a boom 106 may include a recess on a bottom surface of the at least a boom 106. In some embodiments, the recess may be radially symmetrical. As a non-limiting example, part or all of the recess may be substantially cylindrical. As a further nonlimiting example, the recess may closely match the shape of a motor of the at least a propulsor 104, or other object, within. In an embodiment, the recess may include an open, fully covered, and/or partially covered cavity that houses a motor and/or stator of the at least a propulsor 104. In some embodiments, the motor of the at least a propulsor 104 may be mounted on the recess of the at least a boom 106. In some embodiments, the recess may include a lip that could be used as a mating surface. In some embodiments, the recess may include one or more mating surfaces. In some embodiments, the mating surface may be configured on the recess in the at least a boom 106 to contact the mating flange. In some embodiments, the motor of the at least a propulsor 104 may include a mating flange on a stator of the motor. In some embodiments, the mating flange may be welded to the at least a boom 106 such that the stator is affixed to the at least a boom 106. As a non-limiting example, the mating flange may be welded to the at least a boom using standard welding practices such as Arc, MIG (metal, inert gas), TIG (Tungsten Inert Gas), or the like. As another non-limiting example, the mating flange may be fixed to the at least a boom 106 using mechanical methods such as using bolts, rivets, adhesives, and the like. In some embodiments, the mating flange may be a structural channel that is configured to resist a moment along an axis of a propulsor shaft of the at least a propulsor 104. “Moment”, as used in this disclosure, is a measure of rotational effort about an axis. Moments may be used to describe rotational efforts acting on static components. In this instance, the mating flange may be configured such it resists movement from side to side of the at least a propulsor. In some embodiments, the mating flange may be attached to the mating surface using methods mentioned above. Additionally without limitation, additional disclosure related to the at least a boom 106 may be found in U.S. patent application Ser. No. 17/564,404, filed on Dec. 29, 2021, and entitled “SYSTEM FOR A VERTICAL TAKEOFF AND LANDING AIRCRAFT WITH AN IN-BOOM LIFT PROPULSOR,” the entirety of which is incorporated herein by reference.

With continued reference to FIG. 1, at least a boom 106 includes a natural frequency. As used in this disclosure, a “natural frequency” is the frequency or rate that an object vibrates naturally in the absence of a driving force. In some embodiments, the object may include one or more natural frequency. In some embodiments, the natural frequency (fₙ) may be calculated using the following formula:

$${f}_{n} = \frac{1}{2 π} \times \sqrt{\frac{k}{m}} ,$$

wherein k represents stiffness of an object and m represents a mass of the object. In some embodiments, the natural frequency of at least a boom 106 may be determined by adjusting stiffness of the at least a boom 106. As used in this disclosure, “stiffness” is the extent to which an object resists deformation in response to an applied force. As a non-limiting example, the natural frequency of the at least a boom 106 may increase by increasing the stiffness of the at least a boom 106. In some embodiments, stiffness of the at least a boom 106 may be determined by adjusting sectional shapes of the at least a boom 106. As a non-limiting example, the sectional shapes may include square, circle, hollow circle, hollow square, and the like. In some embodiments, stiffness of the at least a boom 106 may be determined by using different materials. As a nonlimiting example, stronger materials may lead to greater stiffness. In some embodiments, stiffness of the at least a boom 106 may be adjusting density of the at least a boom 106. As a non-limiting example, the number of ribs in the structure of boom 106 may be increased to increase stiffness. In some embodiments, the natural frequency of the at least a boom 106 may be determined by adjusting the mass of the at least a boom 106. As a non-limiting example, the natural frequency of the at least a boom 106 may decrease by increasing the mass of the at least a boom 106. In some embodiments, the natural frequency of the at least a boom 106 may be estimated using formulas for the natural frequency of a beam under certain constrains. For example, in some embodiments, the natural frequency of the at least a boom 106 may be calculated using the following formula:

$${f}_{n} = \frac{π}{2} \sqrt{\frac{EI}{m {L}^{4}}} ,$$

wherein E is the elastic modulus, I is the area moment of inertia (MOI) and L is the length of an object. In some embodiments, natural frequency of at least a boom 106 may be determined by adjusting a length of the at least a boom 106. In some embodiments, the natural frequency of at least a boom 106 may be adjusted by altering the location of the support points (as a non-limiting example, boom 106's connection with wing 120 and/or tail 112) of the boom 106. With continued reference to FIG. 1, a natural frequency of at least a boom 106 is a fraction of a maximum driving frequency of at least a propulsor 104. In some embodiments, without limitation, the natural frequency of the at least a boom 106 may be 10%, 17%, 25%, 30%, 43%, 78%, 90%, 100%, and the like. As a non-limiting example, the natural frequency of the at least a boom 106 may be 3.5 Hz when maximum driving frequency of the at least a propulsor 104 is 60 Hz, wherein the natural frequency of the at least a boom 106 is 17% of the maximum driving frequency of the at least a propulsor 104. As another non-limiting example, the natural frequency of the at least a boom 106 may be 60 Hz when the maximum driving frequency of the at least a propulsor 104 is 60 Hz, wherein the natural frequency of the at least a boom is 100% of the maximum driving frequency.

With continued reference to FIG. 1, in an embodiment, at least a propulsor 104 may include a maximum driving frequency below a natural frequency of at least a boom 106. As a non-limiting example, the maximum driving frequency of the at least a propulsor 104 may be 20 Hz while the natural frequency of the at least a boom 106 is 30 Hz. In another embodiment, the maximum driving frequency of the at least a propulsor 104 may be higher than the natural frequency of the at least a boom 106. As a non-limiting example, the maximum driving frequency of the at least a propulsor 104 may be 50 Hz while the natural frequency of the at least a boom 106 is 20 Hz. In some embodiments, the maximum driving frequency of the at least a propulsor may be separated to the natural frequency of the at least a boom 106. As used in this disclosure, “a maximum driving frequency being separated to a natural frequency” refers to the maximum driving frequency being not equal to the natural frequency. As a non-limiting example, the at least a propulsor 104 may be configured to include the maximum driving frequency that is not equal to the natural frequency of the at least a boom 106. As a non-limiting example, the maximum driving frequency of the at least a propulsor 104 may not include 20 Hz when the natural frequency of the at least a boom is 20 Hz. In some embodiments, when the driving frequency is equal to the natural frequency, it may result in resonance. As used in this disclosure, a “resonance” is a phenomenon in which an external force or a vibrating system forces another system around it to vibrate with greater amplitude. In some embodiments, the resonance between the at least a propulsor 104 and the at least a boom 106 may cause a failure of an electric aircraft. As a non-limiting example, the failure of the system may include destruction of the structure of the electric aircraft.

With continued reference to FIG. 1, in some embodiments, at least a boom 106 may protect at least a propulsor 104 from a damage. In some embodiments, the damage on the at least a propulsor 104 and an electric aircraft may be caused by, but not limited to, torque created by a rotor of the at least a propulsor 104, vibrations generated from a motor of the at least a propulsor 104, and/or environmental factors. As a non-limiting example, the environmental factor may include weather, such as rain, wind, and the like. In some embodiments, the at least a boom 106 may absorb torque exerted by the rotation of the rotor of the at least a propulsor 104 by using a bearing cartridge. As used in this disclosure, a “bearing cartridge” is an element that constrains relative motion to only the desired motion and reduces friction between moving parts. The bearing cartridge disclosed herein may be consistent with bearing cartridge 240 disclosed with respect to FIG. 2. In some embodiments, the bearing cartridge may be attached to the at least a boom 106 such that it transfers torque from the motor of the at least a propulsor 104 to the at least a boom 106. As used in this disclosure, a “torque” is a measure of force that causes an object to rotate about an axis in a direction. In some embodiments, the bearings may transfer loads between rotation and stationary members, such as the rotor and the stator of the at least a propulsor 104, allowing the at least a boom 106 to protect the electric aircraft from damages from torque. In another embodiment, the at least a boom may protect the electric aircraft from moment generated by a mating flange. In some embodiments, the mating flange, attached to the stator of the at least a propulsor 104, may include moment along an axis of a shaft. In some embodiments, the at least a boom 106 may counteract the moment using the mating surface. This may help prevent damages to the motor of the at least a propulsor 104. In another embodiment, the at least a boom 106 may protect the motor of the at least a propulsor 104 from vibrational forces. A “vibration” as used in this disclosure is an oscillation about an equilibrium point of an object. In some embodiments, the at least a boom 106 may dampen the vibrations from the motor of the at least a propulsor 104 such that they do not affect the electric aircraft. In another embodiment, the at least a boom 106 may protect the motor of the at least a propulsor 104 from environmental damages. In some embodiments, the motor of the at least a propulsor 104 may be enclosed within the at least a boom 106 such that the at least a boom 106 acts as a shield from the environmental elements. As a non-limiting example, the environmental elements may include rain, debris, wind, and the like. In some embodiments, the at least a boom 106 may attenuate vibration generated from at least a propulsor 104 using a damping material. As used in this disclosure, a “damping material” is a material that dissipates a vibration force applied to an object. As a non-limiting example, the damping material may include rubber, polyurethane, polyvinyl chloride, gasket, and the like. As a non-limiting example, the damping material may be placed between at least a boom 106 and at least a propulsor 104, where propulsor 104 is attached to boom 106. In some embodiments, damping material may include a foam. In some embodiments, damping material may include a rubber.

With continued reference to FIG. 1, aircraft 100 may include a fuselage 116. In one or more embodiments, and as used in this disclosure, a “fuselage” is a main body of an aircraft. In one or more embodiments, fuselage 116 may include the entirety of aircraft except for a cockpit, nose, wings, empennage, nacelles, flight components, such as any and all control surfaces and propulsors. Fuselage 116 may contain a payload of aircraft. In one or more embodiments, airframe may form fuselage 116. For example, and without limitation, one or more structural elements of airframe may be used to form fuselage 116. For the purposes of this disclosure, “structural elements” include elements that physically support a shape and structure of an aircraft. Structural elements may take a plurality of forms, alone or in combination with other types. In one or more embodiments, a structural element may include a carbon fiber composite structure, as previously mentioned. The carbon fiber composite structure is configured to include high stiffness, high tensile strength, low weight to strength ratio, high chemical resistance, high temperature tolerance, and low thermal expansion. In one or more embodiments, a carbon fiber composite may include one or more carbon fiber structures comprising a plastic resin and/or graphite. For example, a carbon fiber composite may be formed as a function of a binding carbon fiber to a thermoset resin, such as an epoxy, and/or a thermoplastic polymer, such as polyester, vinyl ester, nylon, and the like thereof. Structural element may vary depending on a construction type of aircraft. For example, and without limitation, structural element may vary if forming the portion of aircraft that is fuselage 116. Fuselage 116 may include a truss structure. A truss structure may be used with a lightweight aircraft and include welded steel tube trusses. A “truss,” as used in this disclosure, is an assembly of beams that create a rigid structure, often in combinations of triangles to create three-dimensional shapes. A truss structure may alternatively comprise wood construction in place of steel tubes, or a combination thereof. In embodiments, structural elements may include steel tubes and/or wood beams.

With continued reference to FIG. 1, in one or more embodiments, fuselage 116 may include and/or be constructed using geodesic construction. Geodesic structural elements may include stringers wound about formers (which may be alternatively called station frames) in opposing spiral directions. A “stringer,” as used in this disclosure, is a general structural element that may include a long, thin, and rigid strip of metal or wood that is mechanically connected to and spans a distance from station frame to station frame to create an internal skeleton on which to mechanically connect aircraft skin. A former (or station frame) may include a rigid structural element that is disposed along a length of an interior of aircraft fuselage 116 orthogonal to a longitudinal (nose to tail) axis of aircraft and may form a general shape of fuselage 116. The former may include differing cross-sectional shapes at differing locations along fuselage 116, as the former is the structural element that informs the overall shape of a fuselage 116 curvature. In embodiments, the skin may be anchored to formers and strings such that an outer mold line (OML) of a volume encapsulated by formers and stringers comprises the same shape as aircraft when installed. In other words, former(s) may form a fuselage's ribs, and the stringers may form the interstitials between such ribs. The spiral orientation of stringers about formers may provide uniform robustness at any point on fuselage 116 such that if a portion sustains damage, another portion may remain largely unaffected. Aircraft skin may be attached to underlying stringers and formers and may interact with a fluid, such as air, to generate lift and perform maneuvers.

With continued reference to FIG. 1, in some embodiments, aircraft 100 may include airframe is a mechanical structure of an aircraft 100. The airframe may include a fuselage 116, a tail 112, a wing, and/or landing gear, a boom 106, and the like. In one or more embodiments, the airframe includes a structural element configured to provide support and shape to aircraft 100. The airframe structure may include one or more skid plates and/or landing gears. The airframe structure may include a truss, monocoque construction, semi-monocoque construction, and the like thereof. The airframe structure may be comprised of one or more metallic compounds such as aluminum, steel, titanium, composites, and the like thereof. In one or more embodiments, airframe may include a plurality of structural elements. In other embodiments, the airframe may include a plurality of airframes. In one or more embodiments, airframe may include various types of construction. For instance, and without limitation, the airframe may include a monocoque construction, semi-monocoque construction, a truss with canvas construction, or a truss with corrugated plate construction. For example, and without limitation, fuselage 116 may include and/or be constructed using monocoque construction. Monocoque construction may include a primary structure that forms a shell, such as skin, and supports physical loads. Monocoque fuselages are fuselages in which aircraft skin or shell is also the primary structure. In monocoque construction, aircraft skin may support tensile and compressive loads within itself and may, in some exemplary embodiments, be characterized by the absence of internal structural elements. The aircraft skin in this construction method is rigid and can sustain its shape with no structural assistance from underlying skeleton-like elements. In one or more non-limiting embodiments, a monocoque fuselage may include an aircraft skin made from plywood layered in varying grain directions, epoxy-impregnated fiberglass, carbon fiber, or any combination thereof.

With continued reference to FIG. 1, in other embodiments, an airframe may include a semi-monocoque construction. A semi-monocoque construction, as used in this disclosure, is a partial monocoque construction, where a monocoque construction is described above detail. In a semi-monocoque construction, fuselage 116 may derive some structural support from stressed the skin and some structural support from an underlying frame structure made of structural elements. Formers or station frames can be seen running transverse to the long axis of fuselage 116 with circular cutouts which are generally used in real-world manufacturing for weight savings and for the routing of electrical harnesses and other modern on-board systems. In a semi-monocoque construction, stringers are thin, long strips of material that run parallel to fuselage's long axis. Stringers may be mechanically connected to formers permanently, such as with rivets. The skin may be mechanically connected to stringers and formers permanently, such as by rivets as well. A person of ordinary skill in the art will appreciate, upon reviewing the entirety of this disclosure, that there are numerous methods for mechanical fastening of components like screws, nails, dowels, pins, anchors, adhesives like glue or epoxy, or bolts and nuts, to name a few. A subset of fuselage under the umbrella of semi-monocoque construction includes unibody vehicles. Unibody, which is short for “unitized body” or alternatively “unitary construction”, vehicles are characterized by a construction in which the body, floor plan, and chassis form a single structure. A unibody may be characterized by internal structural elements like formers and stringers being constructed in one piece, integral to aircraft skin as well as any floor construction like a deck.

With continued reference to FIG. 1, stringers and formers, which may account for the bulk of an aircraft structure excluding monocoque construction, may be arranged in a plurality of orientations depending on aircraft operation and materials. Stringers may be arranged to carry axial (tensile or compressive), shear, bending or torsion forces throughout their overall structure. Due to their connection to aircraft skin, aerodynamic forces exerted on aircraft skin will be transferred to stringers. A location of stringers greatly informs the type of forces and loads applied to each and every stringer, all of which may be handled by material selection, cross-sectional area, and mechanical connecting methods of each member. A similar assessment may be made for formers. In general, formers may be significantly larger in cross-sectional area and thickness, depending on location, than stringers. Both stringers and formers may comprise aluminum, aluminum alloys, graphite epoxy composite, steel alloys, titanium, or an undisclosed material alone or in combination. Additionally and without limitation, more disclosure of the airframe disclosed herein may be found in U.S. patent application Ser. No. 18/096,995, filed on Jan. 13, 2023, and titled “A STRUCTURE OF AN ELECTRIC AIRCRAFT,” the entirety of which is incorporated by reference herein in its entirety.

With continued reference to FIG. 1 in some embodiments, aircraft 100 may include wing 120. As used in this disclosure, a “wing” is a type of fin that produces lift while moving through a fluid. As a non-limiting example, the fluid may include air. The wing disclosed herein is described further in detail below. In some embodiments, the lift generated by wing 120 may depend on speed of airflow, density of air, total area of wing 120 and/or segment thereof, and/or an angle of attack between air and wing 120. In some embodiments, wing 120 may be a single piece. In some embodiments, wing 120 may include multiple pieces. In some embodiments, wing 120 may run from a left side of an aircraft to a right side of the aircraft as shown as a non-limiting example in FIG. 1. In some embodiments, wing 120 may be mounted to a fuselage of an aircraft. As a non-limiting example, wing 120 may be a low wing, wherein the low wing is a wing mounted near or below a bottom of the fuselage. As another non-limiting example, wing 120 may be a mid-wing, wherein the mid wing is a wing mounted approximately halfway up the fuselage. As another non-limiting example, wing 120 may be a high wing, wherein the high wing is a wing mounted on an upper part of the fuselage. As another non-limiting example, wing 120 may be a parasol wing, wherein the parasol wing is a wing that is raised above the upper part of the fuselage, wherein the wing may be raised using cabane struts, pylons, pedestals, or the like. In some embodiments, structure 100 may include one or more wings 104. As a non-limiting example, wing 120 may include a monoplane, wherein the monoplane may include one wing. As another non-limiting examples, wing 120 may be a biplane, wherein the biplane may include two wings of similar size, stacked one above the other. As another non-limiting examples, wing 120 may be a triplane, quadruplane, multiplane, and the like. In some embodiments, wing 120 may include closed wing, wherein the closed wing may include two wings that are merged or joined structurally at or near the tips in some way. In an embodiment, wing 120 may be attached to the fuselage with dihedral angle. As used in this disclosure, “dihedral angle” is an upward angle from a horizontal of a wing of an aircraft. As a non-limiting example, the dihedral angle may include 1°, 2.5°, 3°, 5°, 7.5°, and the like. In another embodiment, wing 120 may be attached to the fuselage with anhedral angle. As used in this disclosure, an “anhedral angle” is a negative dihedral angle, that is a downward angle from a horizontal of a wing. As a non-limiting example, the anhedral angle may include 1°, 2°, 3°, 4°, 5°, 7.5°, and the like. In some embodiments, wing 120 may be flat. As a non-limiting example, the dihedral angle may be 0°. In some embodiments, wing 120 may include a sweep angle. As used in this disclosure, a “sweep angle” is the angle at which a wing is translated backwards or forwards relative to a root chord of the wing. As used in this disclosure, a “root chord” is a place where a wing joins an aircraft's fuselage. As a non-limiting example, wing 120 may include the sweep angle of 5°, 10°, 19°, 25°, 33.5°, 42°, 57°, and the like. In some embodiments, wing 120 may be straight. As a non-limiting example, wing 120 may include the sweep angle of 0°. In some embodiments, wing 120 may include constant chord, wherein the entire wing has parallel leading edges and trailing edges. In some embodiments, wing 120 may include tapered wing, wherein the wing narrows towards the tip. In some embodiments, wing 120 may include elliptical wing, wherein leading edges and trailing edges of wing 120 are curved such that the chord length varies elliptically with respect to the wingspan.

Referring now to FIG. 2, an embodiment of an integrated electric propulsion assembly 200 is illustrated. The integrated electric propulsion assembly may be consistent with a propulsor 104 disclosed with respect to FIG. 1. In some embodiments, the integrated electric propulsion assembly 200 may include at least a stator 204. Stator 204, as used herein, is a stationary component of a motor and/or motor assembly. In an embodiment, stator 204 includes at least a first magnetic element 208. As used herein, first magnetic element 208 is an element that generates a magnetic field. For example, first magnetic element 208 may include one or more magnets which may be assembled in rows along a structural casing component. Further, first magnetic element 208 may include one or more magnets having magnetic poles oriented in at least a first direction. The magnets may include at least a permanent magnet. Permanent magnets may be composed of, but are not limited to, ceramic, alnico, samarium cobalt, neodymium iron boron materials, any rare earth magnets, and the like. Further, the magnets may include an electromagnet. As used herein, an electromagnet is an electrical component that generates magnetic field via induction; the electromagnet may include a coil of electrically conducting material, through which an electric current flow to generate the magnetic field, also called a field coil of field winding. A coil may be wound around a magnetic core, which may include without limitation an iron core or other magnetic material. The core may include a plurality of steel rings insulated from one another and then laminated together; the steel rings may include slots in which the conducting wire will wrap around to form a coil. A first magnetic element 208 may act to produce or generate a magnetic field to cause other magnetic elements to rotate, as described in further detail below. Stator 204 may include a frame to house components including at least a first magnetic element 208, as well as one or more other elements or components as described in further detail below. In an embodiment, a magnetic field can be generated by a first magnetic element 208 and can comprise a variable magnetic field. In embodiments, a variable magnetic field may be achieved by use of an inverter, a controller, or the like. In an embodiment, stator 204 may have an inner and outer cylindrical surface; a plurality of magnetic poles may extend outward from the outer cylindrical surface of the stator. In an embodiment, stator 204 may include an annular stator, wherein the stator is ring-shaped. In an embodiment, stator 204 is incorporated into a DC motor where stator 204 is fixed and functions to supply the magnetic fields where a corresponding rotor, as described in further detail below, rotates.

With continued reference to FIG. 2, integrated electric propulsion assembly 200 may include an integrated rotor. As used herein, a rotor is a portion of an electric motor that rotates with respect to a stator of the electric motor, such as stator 204. integrated electric propulsion assembly 200 may be any device or component that consumes electrical power on demand to propel an aircraft or other vehicle while on ground and/or in flight. Propulsor 104 may include one or more propulsive devices. In an embodiment, propulsor 104 can include a thrust element which may be integrated into the propulsor. A thrust element may include any device or component that converts the mechanical energy of a motor, for instance in the form of rotational motion of a shaft, into thrust in a fluid medium. For example, a thrust element may include without limitation a marine propeller or screw, an impeller, a turbine, a pump-jet, a paddle or paddle-based device, or the like. As another non-limiting example, integrated electric propulsion assembly 200 may include an eight-bladed pusher propeller, such as an eight-bladed propeller mounted behind the engine to ensure the drive shaft is in compression. Persons skilled in the art, upon reviewing the entirety of this disclosure, will be aware of various devices that may be used as at least a thrust element. As used herein, a propulsive device may include, without limitation, a device using moving or rotating foils, including without limitation one or more rotors, an airscrew or propeller, a set of airscrews or propellers such as contra-rotating propellers, a moving or flapping wing, or the like.

With continued reference to FIG. 2, in an embodiment, integrated electric propulsion assembly 200 may include at least a blade 212. As another non-limiting example, propulsor 104 may include an eight-bladed pusher propeller, such as an eight-bladed propeller mounted behind the engine to ensure the drive shaft is in compression. Persons skilled in the art, upon reviewing the entirety of this disclosure, will be aware of various devices that may be used as the propulsor. In an embodiment, when propulsor 104 twists and pulls air behind it, it will, at the same time, push the aircraft forward with an equal amount of force. The more air pulled behind the aircraft, the more the aircraft is pushed forward.

With continued reference to FIG. 2, in an embodiment, thrust element may include a helicopter rotor incorporated into integrated electric propulsion assembly 200. A helicopter rotor, as used herein, may include one or more blade or wing elements driven in a rotary motion to drive fluid medium in a direction axial to the rotation of the blade or wing element. Its rotation is due to the interaction between the windings and magnetic fields which produces a torque around the rotor's axis. A helicopter rotor may include a plurality of blade or wing elements.

With continued reference to FIG. 2, integrated electric propulsion assembly 200 can include a hub 216 rotatably mounted to stator 204. Rotatably mounted, as described herein, is functionally secured in a manner to allow rotation. Hub 216 is a structure which allows for the mechanically connected of components of the integrated rotor assembly. In an embodiment, hub 216 can be mechanically connected to propellers or blades. In an embodiment, hub 216 may be cylindrical in shape such that it may be mechanically joined to other components of the rotor assembly. Hub 216 may be constructed of any suitable material or combination of materials, including without limitation metal such as aluminum, titanium, steel, or the like, polymer materials or composites, fiberglass, carbon fiber, wood, or any other suitable material. Hub 216 may move in a rotational manner driven by interaction between stator and components in the rotor assembly. Persons skilled in the art, upon reviewing the entirety of this disclosure, will be aware of various structures that may be used as or included as hub 216, as used and described herein.

With continued reference to FIG. 2, integrated electric propulsion assembly 200 may include a second magnetic element 220, which may include one or more further magnetic elements. Second magnetic element 220 generates a magnetic field designed to interact with first magnetic element 208. Second magnetic element 220 may be designed with a material such that the magnetic poles of at least a second magnetic element are oriented in an opposite direction from first magnetic element 208. In an embodiment, second magnetic element 220 may be affixed to hub 216. Affixed, as described herein, is the attachment, fastening, connection, and the like, of one component to another component. For example, and without limitation, affixed may include bonding the second magnetic element 220 to hub 216, such as through hardware assembly, spot welding, riveting, brazing, soldering, glue, and the like. Second magnetic element 220 may include any magnetic element suitable for use as a first magnetic element 208. For instance, and without limitation, second magnetic element may include a permanent magnet and/or an electromagnet. Second magnetic element 220 may include magnetic poles oriented in a second direction opposite of the orientation of the poles of first magnetic element 208. In an embodiment, electric propulsion assembly 200 includes a motor assembly incorporating stator 204 with a first magnet element and second magnetic element 220. First magnetic element 208 includes magnetic poles oriented in a first direction, a second magnetic element includes a plurality of magnetic poles oriented in the opposite direction than the plurality of magnetic poles in the first magnetic element 208.

With continued reference to FIG. 2, second magnetic element 220 may include a plurality of magnets attached to or integrated in hub 216. In an embodiment, hub 216 may incorporate structural elements of the rotor assembly of the motor assembly. As a non-limiting example hub 216 may include a motor inner magnet carrier 224 and motor outer magnet carrier 228 incorporated into the hub 216 structure. In an embodiment motor inner magnet carrier 224 and motor outer magnet carrier 228 may be cylindrical in shape. In an embodiment, motor inner magnet carrier 224 and motor out magnet carrier 216 may be any shape that would allow for a fit with the other components of the rotor assembly. In an embodiment, hub 216 may be short and wide in shape to reduce the profile height of the rotating assembly of electric propulsion assembly 200. Reducing the profile assembly height may have the advantage of reducing drag force on the external components. In an embodiment, hub 216 may also be cylindrical in shape so that fitment of the components in the rotor assembly are structurally rigid while leaving hub 216 free to rotate about stator.

With continued reference to FIG. 2, in an embodiment, motor outer magnet carrier 228 may have a slightly larger diameter than motor inner magnet carrier 224, or vice-versa. First magnetic element 208 may be a productive element, defined herein as an element that produces a varying magnetic field. Productive elements will produce magnetic field that will attract and other magnetic elements, including a receptive element. Second magnetic element may be a productive or receptive element. A receptive element will react due to the magnetic field of a first magnetic element 208. In an embodiment, first magnetic element 208 produces a magnetic field according to magnetic poles of first magnetic element 208 oriented in a first direction. Second magnetic element 220 may produce a magnetic field with magnetic poles in the opposite direction of the first magnetic field, which may cause the two magnetic elements to attract one another. Receptive magnetic element may be slightly larger in diameter than the productive element. Interaction of productive and receptive magnetic elements may produce torque and cause the assembly to rotate. Hub 216 and rotor assembly may both be cylindrical in shape where rotor may have a slightly smaller circumference than hub 216 to allow the joining of both structures. Coupling of hub 216 to stator 204 may be accomplished via a surface modification of either hub 216, stator 204 or both to form a locking mechanism. Coupling may be accomplished using additional nuts, bolts, and/or other fastening apparatuses. In an embodiment, an integrated rotor assembly as described above reduces profile drag in forward flight for an electric aircraft. Profile drag may be caused by a number of external forces that the aircraft is subjected to. By incorporating a the propulsor into hub 216, a profile of integrated electric propulsion assembly 200 may be reduced, resulting in a reduced profile drag, as noted above. In an embodiment, the rotor, which includes motor inner magnet carrier 224, motor outer magnet carrier 228, the propulsor is incorporated into hub 216 to become one integrated unit. In an embodiment, inner motor magnet carrier 212 rotates in response to a magnetic field. The rotation causes hub 216 to rotate. This unit can be inserted into integrated electric propulsion assembly 200 as one unit. This enables ease of installation, maintenance, and removal.

With continued reference to FIG. 2, stator 204 may include a through-hole 232. Through-hole 232 may provide an opening for a component to be inserted through to aid in attaching propulsor with integrated rotor to stator. In an embodiment, through-hole 232 may have a round or cylindrical shape and be located at a rotational axis of stator 204. Hub 216 may be mounted to stator 204 by means of a shaft 236 rotatably inserted though through hole 232. Through-hole 232 may have a diameter that is slightly larger than a diameter of shaft 236 to allow shaft 236 to fit through through-hole 232 to connect stator 204 to hub 216. Shaft 236 may rotate in response to rotation of the propulsor.

With continued reference to FIG. 2, integrated electric propulsion assembly 200 may include a bearing cartridge 240. Bearing cartridge 240 may include a bore. Shaft 236 may be inserted through the bore of bearing cartridge 240. Bearing cartridge 240 may be attached to a structural element of a vehicle. Bearing cartridge 240 functions to support the rotor and to transfer the loads from the motor. Loads may include, without limitation, weight, power, magnetic pull, pitch errors, out of balance situations, and the like. A bearing cartridge 240 may include a bore. a bearing cartridge 240 may include a smooth metal ball or roller that rolls against a smooth inner and outer metal surface. The rollers or balls take the load, allowing the device to spin. a bearing may include, without limitation, a ball bearing, a straight roller bearing, a tapered roller bearing or the like. a bearing cartridge 240 may be subject to a load which may include, without limitation, a radial or a thrust load. Depending on the location of bearing cartridge 240 in the assembly, it may see all of a radial or thrust load or a combination of both. In an embodiment, bearing cartridge 240 may join integrated electric propulsion assembly 200 to a structure feature. A bearing cartridge 240 may function to minimize the structural impact from the transfer of bearing loads during flight and/or to increase energy efficiency and power of propulsor. a bearing cartridge 240 may include a shaft and collar arrangement, wherein a shaft affixed into a collar assembly. A bearing element may support the two joined structures by reducing transmission of vibration from such bearings. Roller (rolling-contact) bearings are conventionally used for locating and supporting machine parts such as rotors or rotating shafts. Typically, the rolling elements of a roller bearing are balls or rollers. In general, a roller bearing is a is type of anti-friction bearing; a roller bearing functions to reduce friction allowing free rotation. Also, a roller bearing may act to transfer loads between rotating and stationary members. In an embodiment, bearing cartridge 240 may act to keep a the propulsor and components intact during flight by allowing integrated electric propulsion assembly 200 to rotate freely while resisting loads such as an axial force. In an embodiment, bearing cartridge 240 includes a roller bearing incorporated into the bore. a roller bearing is in contact with propulsor shaft 236. Stator 204 is mechanically coupled to inverter housing 240. Mechanically coupled may include a mechanical fastening, without limitation, such as nuts, bolts or other fastening device. Mechanically coupled may include welding or casting or the like. Inverter housing contains a bore which allows insertion by propulsor shaft 236 into bearing cartridge 240.

With continued reference to FIG. 2, electric propulsion assembly 200 may include a motor assembly incorporating a rotating assembly and a stationary assembly. Hub 216, motor inner magnet carrier 224 and propulsor shaft 236 may be incorporated into the rotor assembly of electric propulsion assembly 200 which make up rotating parts of electric motor, moving between the stator poles and transmitting the motor power. As one integrated part, the rotor assembly may be inserted and removed in one piece. Stator 204 may be incorporated into the stationary part of the motor assembly. Stator and rotor may combine to form an electric motor. In embodiment, an electric motor may, for instance, incorporate coils of wire which are driven by the magnetic force exerted by a first magnetic field on an electric current. The function of the motor may be to convert electrical energy into mechanical energy. In operation, a wire carrying current may create at least a first magnetic field with magnetic poles in a first orientation which interacts with a second magnetic field with magnetic poles oriented in the opposite direction of the first magnetic pole direction causing a force that may move a rotor in a direction. For example, and without limitation, a first magnetic element 208 in electric propulsion assembly 200 may include an active magnet. For instance, and without limitation, a second magnetic element may include a passive magnet, a magnet that reacts to a magnetic force generated by a first magnetic element 208. In an embodiment, a first magnet positioned around the rotor assembly, may generate magnetic fields to affect the position of the rotor relative to the stator 204. A controller may have an ability to adjust electricity originating from a power supply and, thereby, the magnetic forces generated, to ensure stable rotation of the rotor, independent of the forces induced by the machinery process. Electric propulsion assembly 200 may include an impeller 244 coupled with the shaft 236. An impeller, as described herein, is a rotor used to increase or decrease the pressure and flow of a fluid and/or air. Impeller 244 may function to provide cooling to electric propulsion assembly 200. Impeller 244 may include varying blade configurations, such as radial blades, non-radial blades, semi-circular blades and airfoil blades. Impeller 214 may further include single and/or double-sided configurations.

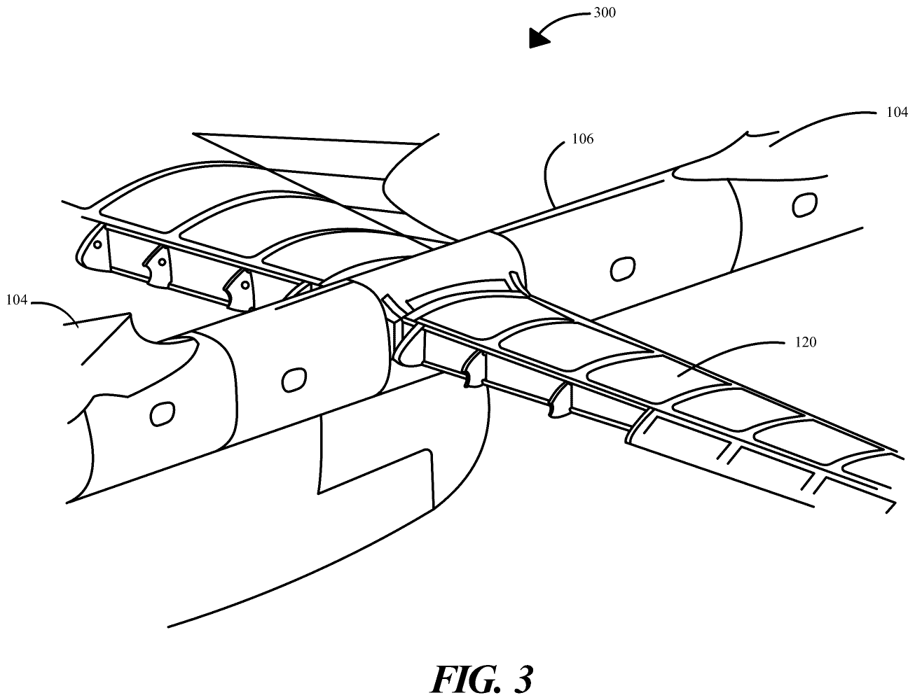

Referring now to FIG. 3, an exemplary embodiment of a portion of structure 300 of an aircraft is illustrated. In some embodiments, structure 300 may include a wing 120. In some embodiments, wing 120 includes an airfoil. An “airfoil,” as used in this disclosure, is a cross-sectional shape of an object whose motion through a gas is capable of generating lift. As a non-limiting example, the object may include wing 120, a sail, blades of propeller, rotor, or turbine, or the like. In an embodiment, wing 120 may include one airfoil. In another embodiment, wing 120 may include a plurality of airfoils. In an embodiment, wing 120 may include a plurality of airfoils in different chord lengths. As used in this disclosure, “chord length” is the length of a chord line. As used in this disclosure, a “chord line” is a straight light connecting leading edge and trailing edge. As used in this disclosure, a “leading edge” is the foremost edge of an airfoil. As used in this disclosure, a “trailing edge” is a rear edge of an airfoil. As a non-limiting example, wing 120 may include the chord length of 3-inch, 3-inch, 5-inch, 30-inch, and the like. In another embodiment, wing 120 may include a plurality of airfoils in different shapes of cambers. As used in this disclosure, a “camber” is curvature of an airfoil from the leading edge to the trailing edge. As a non-limiting example, the camber may include a concave camber. As another non-limiting example, the camber may include a convex camber. In an embodiment, the camber may include an upper camber, wherein the upper camber is a curve of the upper surface of the airfoil. In another embodiment, the camber may include a lower camber, wherein the lower camber is a curve of the lower surface of the airfoil. In some embodiments, the camber may include a mean camber line, wherein the mean camber line is an imaginary line which lies halfway between the upper camber and the lower camber of the airfoil and intersects the chord line at the leading and trailing edges. In an embodiment, the airfoil may include symmetric airfoil, wherein the upper camber and the lower camber are symmetric. In another embodiment, the airfoil may include asymmetric airfoil, wherein the upper camber and the lower camber include different curvature. In some embodiments, a thickness of the airfoil may be measured using the mean camber line, wherein the thickness may be measured perpendicular to the mean camber line. In another embodiment, the thickness of the airfoil may be measured using the chord line, wherein the thickness may be measured perpendicular to the chord line.

With continued reference to FIG. 3, in some embodiments, wing 120 may include an aileron. An “aileron,” as used in this disclosure, is a hinged surface which forms part of the trailing edge of a wing in a fixed-wing aircraft, and which may be moved with mechanical means such as without limitation servomotors, mechanical linkages, or the like. As a non-limiting example, the aileron may include single acting ailerons, wingtip ailerons, frise ailerons, differential ailerons. In an embodiment, the aileron may be mechanically coupled to an aircraft. In some embodiments, wing 120 may include a flap. As used in this disclosure, a “flap” is a high-lift device on a trailing edge of an aircraft wing used to reduce stalling speed of an aircraft wing at a given weight. A “high-lift device,” for the purposes of this disclosure, is a component or mechanism on an aircraft's wing that increases amount of lift produced by the wing. The device may be a fixed component, or a movable mechanism which is deployed when required. Common movable high-lift devices may include flaps and slats. A “slat,” for the purposes of this disclosure, is a high-lift device on a leading edge of an aircraft wing used to allow the wing to produce more lift. The fixed devices may include leading-edge slots, leading edge root extensions, and boundary layer control systems. The flaps, as a non-limiting example, may include plain flaps, split flap, slotted flaps, fowler flaps, leading-edge flap, continuous trailing-edge flap, and the like thereof. “Plain flaps,” as used in this disclosure, are a hinged portion of a trailing edge, which increase curvature of a wing and lift by lowering the trailing edge of the wing. “Split flaps,” as used in this disclosure, are hinged at bottom of a wing. The split flaps may generate drag by disturbing airflow on the underside of wing 120. “Slotted flaps,” as used in this disclosure, are similar to plain flap, but have a slot between trailing edge of a wing and a flap. Slotted flaps may allow high-energy air to flow from underneath a wing up and over a flap to help prevent airflow separation. “Flow separation,” as used in this disclosure, is a detachment of a boundary layer from a surface into a wake. “Fowler flaps,” as used in this disclosure, are flaps that move rearward and downward increasing wing area and curvature. In some embodiments, extending the flaps may increase a camber of a wing, raising maximum lift coefficient or upper limit to a lift a wing can generate. This may allow the aircraft to generate the required lift at a lower speed, reducing stall speed. “Stall speed,” as used in this disclosure, is the minimum speed at which an aircraft must fly to produce a lift. A “stall,” as used in this disclosure, is a reduction in lift coefficient generated by an airfoil as angle of attack increases. The stall may occur when the critical angle of attack of an airfoil is exceeded. “Critical angle of attack,” as used in this disclosure, is angle of attack which produces maximum lift coefficient. In an embodiment, an aircraft's weight, acceleration, altitude may affect stall speed.

With continued reference to FIG. 3, structure 300 includes at least a boom 106. In some embodiments, structure 300 may include a plurality of the at least a boom 106. As a non-limiting example, structure 300 may include two the at least a boom 106, three the at least a boom 106, and the like. In an embodiment, the at least a boom 106 may include a cylindrical body. In another embodiment, the at least a boom 106 may include a cuboid body. In some embodiments, the at least a boom 106 may be hollow. In an embodiment, the at least a boom 106 may be oriented substantially perpendicular to a wingspan of wing 120 as shown as a non-limiting example in FIG. 1. As used in this disclosure, a “wingspan” is an imaginary line drawn from a tip of one wing to a tip of the other. The tip of wing 120 is further described below. In some embodiments, the wingspan may be used to measure a length of wing 120. In some embodiments, the wingspan may be used to orient the at least a boom 106. In another embodiment, the at least a boom 106 may be oriented diagonally to the wingspan of wing 120. In some embodiments, the at least a boom 106 may be attached to at least a portion of a tail of the aircraft as shown as a non-limiting example in FIG. 1.

With continued reference to FIG. 3, in some embodiments, at least a boom 106 is configured to carry at least a propulsor 104. In some embodiments, the at least a propulsor 104 may include a plurality of the at least a propulsor 104. In some embodiments, the at least a propulsor 104 may include a rotor, propeller, a blade, or a blade arrangement. In a non-limiting example, the propulsor 104 may be a lift propulsor. In some embodiments, the vertical lift may be provided during transition of the aircraft between vertical and horizontal modes of flight, along with a forward thrust.

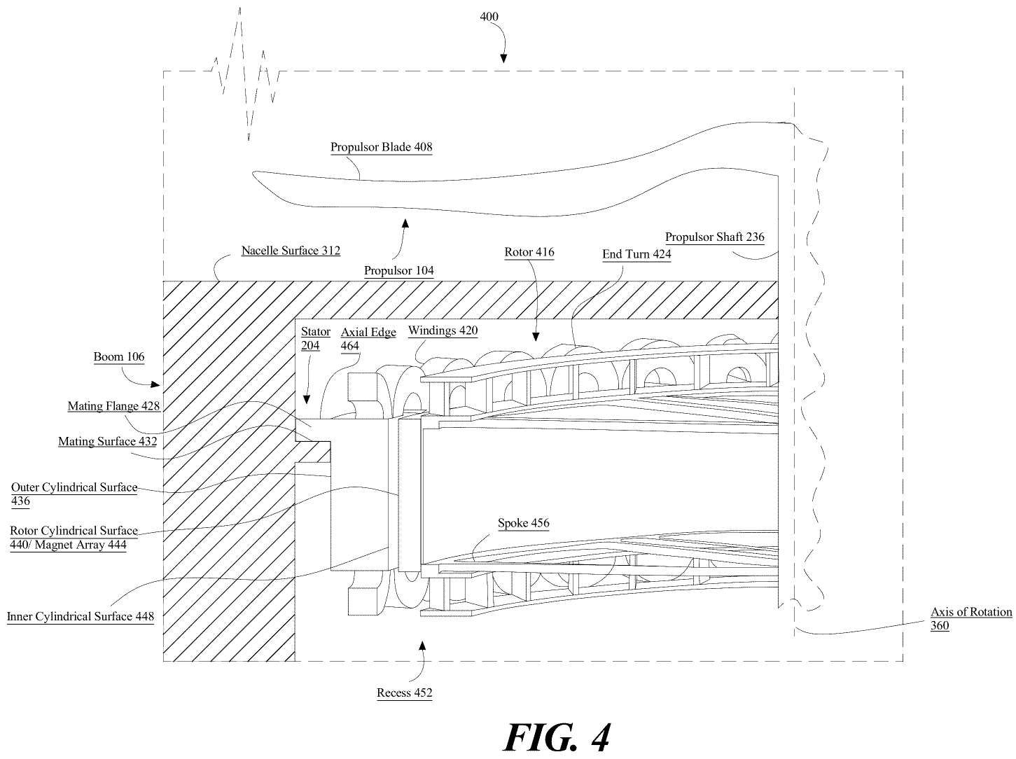

Referring now to FIG. 4, a diagram 400 of the cross-sectional view of a motor assembly in a boom 106. Boom 106 contains a recess 452 on the upper surface of the boom. For example and without limitation, a recess may be radially symmetrical; for instance, part or all of the recess may be substantially cylindrical. As a further nonlimiting example, a recess may closely match the shape of the motor, or other object, within. In an embodiment, a recess may include an open, fully covered, and/or partially covered cavity that houses a motor and/or stator. Recess 452 may include a lip that could be used as a mating surface 432. Recess 452 may include one or more mating surfaces. Mating surface 432 is configured on the recess 452 in boom 106 to contact the mating flange 428. Motor assembly contains a mating flange 428 on stator 204. Mating flange 428 is weld to the boom 106 such that the stator is affixed to aircraft 100. Mating flange 428 can be weld to the boom 106 using standard welding practices such as Arc, MIG (metal, inert gas), TIG (Tungsten Inert Gas), or the like. Mating flange 428 can be fixed to the boom 106 using mechanical methods such as using bolts, rivets, adhesives, and the like. Mating flange 428 may be a structural channel that is configured to resist a moment along an axis of the propulsor shaft. “Moment”, as used in this disclosure, is a measure of rotational effort about an axis. Moments may be used to describe rotational efforts acting on static components. In this instance, the mating flange 428 is configured such it resists movement from side to side of a propeller. Mating flange 428 is attached to mating surface 432 using methods mentioned above. Additionally without limitation, the boom 106 disclosed herein may be consistent with a boom disclosed in U.S. patent application Ser. No. 17/564,404, filed on Dec. 29, 2021 and entitled “SYSTEM FOR A VERTICAL TAKEOFF AND LANDING AIRCRAFT WITH AN IN-BOOM LIFT PROPULSOR,” the entirety of which is incorporated herein by reference.

With continued reference to FIG. 4, boom 106 includes a nacelle surface 412. As used herein, a “nacelle surface” refers to an aerodynamically formed surface. Motor assembly 400 may be housed within the nacelle surface 412 on the boom 106. The surface may redirect downdrafts as well as updrafts or any other passage of air around or at the boom 106 from a propulsor 104. “Aerodynamic”, for the purposes of this disclosure, includes a design for a nacelle that reduces drag and wind resistance as a function of what is housed within. Nacelle surface 412 and boom 106 comprises the same material as the fuselage 104 of the aircraft. Material may be any material suitable for formation of a structural element. Boom 106 may include an opening through which a shaft supporting a rotor 416 and/or portion of a propulsor may pass.

With continued reference to FIG. 4, stator 204 includes an inner cylindrical surface 448 and an outer cylindrical surface 436 each coaxial about an axis of rotation 460 and at least partially defined by an axial edge 464 on either side. Stator 204 may comprise stacked laminations, also known as punching with inner teeth. An outer surface of the stacked laminations may form outer cylindrical surface 436. Inner cylindrical surface 448 and outer cylindrical surface 436 may share a coincident and parallel centerline disposed at the center of each cylindrical surface. Inner cylindrical surface 448 and outer cylindrical surface 436 may include different radii and thus include different sizes. Stator 204 may include windings 420 made of electrically conductive coil wound around a magnetic core, which may include without limitation an iron core or other magnetic material. Specifically, windings 420 may be wound around the inner teeth of the stacked laminations. Coil may include any material that is conductive to electrical current and may include, as a non-limiting example, various metals such as copper, steel, or aluminum, carbon conducting materials, or any other suitable conductive material. Each of windings 420 may form an oval shape with an end turn 424 on either end of windings 420. End turn 424 may extend past at least an axial edge 464 of stator 204. Each end turn 424 may extend past the corresponding at least an axial edge 464 such that a portion of an interior space of each of windings 420 at least partially extends past both at least an axial edge 464. Stator 204 may include one or more magnets which may be assembled in rows along a structural casing component. Further, stator 204 may include one or more magnets having magnetic poles oriented in at least a first direction.

With continued reference to FIG. 4, motor includes a rotor 416 coaxial within stator 204. A rotor 416 is a portion of an electric motor that rotates with respect to a stator 204 of the electric motor, such as stator 204. Rotor 416 includes a rotor cylindrical surface 440, wherein the rotor cylindrical surface 440 and inner cylindrical surface 448 of stator 204 combine to form an air gap 164 between the rotor cylindrical surface 440 and the inner cylindrical surface 448. Rotor cylindrical surface 440 may be disposed opposite and opposing to inner cylindrical surface 448 of stator 204. Rotor 416 may include a propulsor shaft 236. Propulsor shaft 236 may be disposed coaxially and coincidentally within stator 204. Propulsor shaft 236 may be rotatable relative to stator 204, which remains stationary relative to electric aircraft 108. Rotor cylindrical surface 440 may be radially spaced from propulsor shaft 236 such as, for example, in a squirrel cage rotor assembly. At least a spoke 456 may extend from propulsor shaft 236 to one or both of axial edge 464 of rotor cylindrical surface 440. At least a spoke 456 may include a plurality of spokes on each of axial edge 464 of rotor cylindrical surface 440. Rotor 416 may include a plurality of permanent magnets, namely a magnet array 444, disposed radially about the axis of rotation 460 of propulsor shaft 236 which may be parallel and coincident with axis of rotation 460 of motor 100. Magnet array 444 may be positioned on rotor cylindrical surface 440 and radially from propulsor shaft 236, such that rotor cylindrical surface 440 is between magnet array 444 and propulsor shaft 236. Magnet array 444 may be opposite inner cylindrical surface 448 of stator 204 and spaced from the inner cylindrical surface 448 by air gap 164. Rotor cylindrical surface 440 may comprise magnet array 444. Magnet array 444 may include a Halbach array. A Halbach array is a special arrangement of permanent magnets that augments the magnetic field on one side of the array while canceling the field to near zero on the other side of the array. For the purposes of this disclosure, a side of the array is defined as an area disposed relative to the array of magnets, for example, if the Halbach array is disposed radially on the cylindrical surface of the propulsor shaft 236, one side may be captured with the Halbach array, and a second side may be the area outside of the Halbach array. In general, the Halbach array is achieved by having a spatially rotating pattern of magnetization where the poles of successive magnets are not necessarily aligned and differ from one to the next. Orientations of magnetic poles may be repeated in patterns or in successive rows, columns, and arrangements. An array, for the purpose of this disclosure is a set, arrangement, or sequence of items, in this case permanent magnets. The rotating pattern of permanent magnets can be continued indefinitely and have the same effect, and may be arranged in rows, columns, or radially, in a non-limiting illustrative embodiment. One of ordinary skill in the art would appreciate that the area that the Halbach array augments the magnetic field of may be configurable or adjustable. Magnet array 444 may comprise a magnet sleeve forming at least part of rotor cylindrical surface 440 with slits and/or ribs in the magnet sleeve to further dissipate heat. Slits and/or ribs may be unidirectional. Slits and/or ribs may be bidirectional on magnet array 444 such as, for example, in a chevron pattern.

With continued reference to FIG. 4, an end of propulsor shaft 236 may be attached to a propulsor 104. In an embodiment, propulsor 104 may include at least a propulsor blade 408. At least a propulsor blade 408 may include a plurality of propulsor blades. As another non-limiting example, a propulsor may include an eight-bladed pusher propeller, such as an eight-bladed propeller mounted behind the engine to ensure the drive shaft is in compression. Persons skilled in the art, upon reviewing the entirety of this disclosure, will be aware of various devices that may be used as propulsor 104. In an embodiment, when a propulsor twists and pulls air behind it, it will, at the same time, push the aircraft forward with an equal amount of force. The more air pulled behind the aircraft, the more the aircraft is pushed forward. Thrust element may include a helicopter rotor incorporated into propulsor 104. A helicopter rotor, as used herein, may include one or more blade or wing elements driven in a rotary motion to drive fluid medium in a direction axial to the rotation of the blade or wing element. Its rotation is due to the interaction between the windings 420 and magnetic fields which produces a torque around the rotor's axis. A helicopter rotor may include a plurality of blade or wing elements. Additional disclosure related to motor windings can be found in U.S. patent application Ser. No. 17/154,578, filed on Jan. 1, 2021 and entitled “METHODS AND SYSTEMS FOR A STATOR WITH HELICAL WINDINGS CONFIGURED FOR USE IN ELECTRIC AIRCRAFT MOTOR,” the entirety of which is incorporated herein by reference.

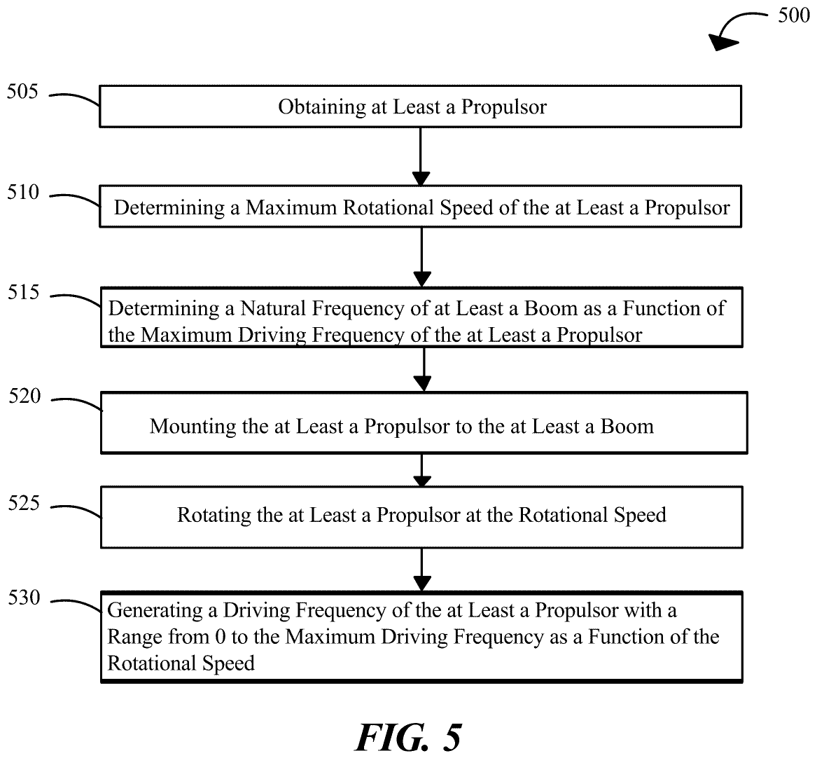

Referring now to FIG. 5, a flow diagram of a method 500 of vibration mitigation for a propulsor and a boom in an electric aircraft is shown. In some embodiments, the electric aircraft may be a vertical takeoff and landing (eVTOL) aircraft. The method 500 includes a step 505 of obtaining at least a propulsor, wherein the propulsor is configured to rotate at rotational speed. In some embodiments, the at least a propulsor may include a lift propulsor. The method 500 includes a step 510 of determining a maximum rotational speed of the at least a propulsor. In some embodiments, the maximum driving frequency of the at least a propulsor may be 60 hertz. The method 500 includes a step 515 of determining a natural frequency of at least a boom as a function of the maximum driving frequency of the at least a propulsor. In an embodiment, the natural frequency of the at least a boom may be 10% of the maximum driving frequency of the at least a propulsor. In another embodiment, the natural frequency of the at least a boom may be 100% of the maximum driving frequency of the at least a propulsor. The method 500 includes a step 520 of mounting the at least a propulsor to the at least a boom. The method 500 includes a step 525 of rotating the at least a propulsor at the rotational speed. The method 500 includes a step 530 of generating a driving frequency of the at least a propulsor with a range from 0 to the maximum driving frequency as a function of the rotational speed, wherein the driving frequency of the at least a propulsor is higher than the natural frequency of the at least a boom. In some embodiments, the driving frequency of the at least a propulsor may be higher than the natural frequency of the at least a propulsor. In some embodiments, the driving frequency of the at least a propulsor is not equal to the natural frequency of the at least a propulsor. In some embodiments, the method 500 may further include attenuating, using the at least a boom, a vibration force to the electric aircraft. This may be implemented as disclosed in reference to FIG. 1-4.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve embodiments according to this disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A system comprising:
a propulsor, wherein the propulsor is configured to propel an electric aircraft through a fluid medium and the propulsor comprises a driving frequency that is generated as a function of a rotational speed of the propulsor when the propulsor propels the electric aircraft through the fluid medium;
a wing extending from a fuselage of the electric aircraft;
a boom extending from the wing and defining a recess; and
a propulsor motor mounted within the recess of the boom, wherein the boom is configured to have a natural frequency that differs from a maximum driving frequency of the propulsor.

2. The system of claim 1, further comprising a tail extending from the fuselage of the electric aircraft, wherein the boom connects to the wing and the tail.

3. The system of claim 1, wherein the recess:
extends between a first opening on an upper surface of the boom and a second opening on a bottom surface of the boom;
is radially symmetrical; and
comprises a flange within the recess that couples with a stator of the motor of the propulsor.

4. The system of claim 1, wherein the recess comprises a mating surface within the boom configured to contact a mating flange of a stator of the propulsor.

5. The system of claim 4, further comprising a damping material positioned between the mating flange and the mating surface, the damping material including at least one of a rubber, polyurethane, polyvinyl chloride, or gasket material.

6. The system of claim 1, wherein the natural frequency of the boom is greater than the maximum driving frequency of the propulsor.

7. The system of claim 2, wherein the propulsor is a first propulsor positioned at a first end of the boom opposite from the tail, and wherein the system further comprises a second propulsor mounted on the boom between the wing and the tail.

8. The system of claim 1, wherein the boom comprises a damping material positioned between the propulsor and the boom where the propulsor is mounted, the damping material configured to attenuate a vibration force to the electric aircraft.

9. The system of claim 1, wherein the maximum driving frequency of the propulsor is greater than the natural frequency of the propulsor.

10. The system of claim 1, wherein:
the wing extends approximately perpendicular to a forward travel direction of the electric aircraft; and
the boom extends from the wing approximately parallel with the forward travel direction of the electric aircraft.

11. A method of vibration mitigation comprising:
obtaining a propulsor, wherein the propulsor is configured to rotate at a rotational speed;
determining a maximum rotational speed of the propulsor;
determining a maximum driving frequency of the propulsor based at least in part on the maximum rotational speed;
determining a natural frequency of a boom for an electric aircraft as a function of the maximum driving frequency of the propulsor, wherein the natural frequency differs from the maximum driving frequency and the electric aircraft comprises:
a fuselage; and
a wing extending from the fuselage, wherein the boom extends from the wing and defines a recess;
mounting the propulsor to the boom by coupling the propulsor within the recess of the boom;
rotating the propulsor at the rotational speed; and
generating a driving frequency of the propulsor as a function of the rotational speed, wherein the driving frequency of the propulsor is different from the natural frequency of the boom.

12. The method of claim 11, wherein the electric aircraft is a vertical takeoff and landing (eVTOL) aircraft.

13. The method of claim 11, wherein the propulsor is a lift propulsor.

14. The method of claim 11, wherein the maximum driving frequency of the propulsor is 60 hertz.

15. The method of claim 11, wherein:
the propulsor is a first propulsor;
mounting the propulsor to the boom comprises mounting the first propulsor to the boom at a first side of the wing; and
the method further comprises mounting a second propulsor to the boom at a second side of the wing opposite the first side of the wing.

16. The method of claim 11, wherein the natural frequency of the boom is less than 100% of the maximum driving frequency of the propulsor.

17. The method of claim 11, wherein determining the natural frequency of the boom comprises adjusting a stiffness of the boom by at least one of:
changing a material for the boom;
adding a damping material to the boom; or
changing a cross-sectional shape of the boom.

18. The method of claim 11, further comprising attenuating, using a damping material between the propulsor and the boom, a vibration force to the electric aircraft.

19. The method of claim 11, wherein the maximum driving frequency of the propulsor is greater than the natural frequency of the propulsor.

20. The method of claim 11, wherein the recess extends from a first opening on an upper surface of the boom to a second opening on a bottom surface of the boom and wherein mounting the propulsor to the boom comprises coupling the propulsor within the recess by coupling a stator of the propulsor to a flange within the recess.
